(19) United States
(12) Patent Application Publication
(10) Pub. No.: US 2006/0088294 A1
(43) Pub. Date: Apr. 27, 2006

(54) Image recorder

(75) Inventors: Norihiko Nakano, Fujisawa (JP); Tsutomu Usui, Yokohama (JP); Mitsuyoshi Hirota, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/137,079

(22) Filed: May 24, 2005

(30) Foreign Application Priority Data
Oct. 21, 2004 (JP) 2004-306318

(51) Int. Cl. H04N 7/26

(52) U.S. Cl. 386/111; 386/112

(57) ABSTRACT

An image recorder is provided which assures recording even if its primary recorder is inoperable. The recorder includes an image compression processor to compress input images, a buffer to buffer the compressed image data, a first recorder to record the image data, and a second recorder for recording the image data if the first recorder is inoperable. The second recorder typically operates with a recording rate different from that of the first data recorder.

### BACKGROUND OF THE INVENTION

1. Field of the Invention

The present invention relates to information recorders provided with multiple recording means, and more specifically, to an image recorder for image recording.

2. Description of the Prior Art

The background technology related to this application is described in JP-A-2001-14801. The system described there proposes to “exemplify a monitoring system superior to conventional in terms of image data generation, compression, decompression, and recording, and system management.” An exemplary recording method described therein is defined “to decrease the number of frames in image data per unit time for image recording onto an MO disk 81 for extending the recording time of the MO disk 81.”

### BRIEF SUMMARY OF THE INVENTION

Although a method for decreasing the amount of data to extend recording time is described in the above JP '14801 document, there is no technique described for controlling a recording rate when a main recording means is not available for image recording. Image recorders are often provided as a part of security systems under the control of security firms. Whenever image recorders fail to operate properly, maintenance staff from the security firm must make repair visits to the sites at which the image recorders are located. Security firms and the owners of the security systems bear increased maintenance-related costs if breakdown rates of image recorders arise.

To decrease the breakdown rate of the recorders, one type of image recorder may include a plurality of recording means provided by a hard disk drive (HDD) and a memory card incorporating semiconductor memory. In this type of system, a large-capacity HDD is generally the first choice for image recording. If the HDD fails to operate correctly, the memory card serves as an alternative for image recording. This configuration enables the system to perform image recording without interruption even with HDD failure, and therefore decreases the breakdown rate of the recorders. With an image recorder that includes the HDD and memory card configurations, image recording can be continuously performed even when the HDD fails, thus eliminating the need for security firm maintenance staffs to immediately make on-site repairs to malfunctioning recorders.

Of course, image recorders that include HDD and memory card configurations may exhibit problems. One problem with such image recorders is that the memory cards are smaller in capacity in comparison to the HDDs and therefore, if continuous recording employs the recording rate used by the HDDs, the memory cards usually the capacity of the HDDs. Another problem is that the recording rate varies depending on the placement conditions of the image recorders and this tendency results in a variation of recordable time even if the memory cards have the same capacity as the HDDs. Therefore, this problem may undermine any guarantee of accurate recording duration estimates.

Therefore, even if the system can continue image recording after HDD failure, the recording time made available by the system is unstable. This instability may necessitate on-site supervision and/or adjustments by security firm maintenance staffs or system managers to prevent any gap in recording time periods. The present invention provides an image recorder that is capable of ensuring uninterrupted recording time, irrespective of the image recorder's placement conditions, and even if its main recording means fails to operate correctly or is unavailable for recording.

### BRIEF DESCRIPTION OF THE DRAWINGS

FIG. 1 is a schematic diagram showing an image recorder of a first embodiment of the present invention;

FIG. 2 is a diagram showing image data recording in the image recorder of the first embodiment;

FIG. 3 is a sequence diagram of a recording rate calculation process in the image recorder of the first embodiment;

FIG. 4 is a schematic diagram showing an image recorder of a second embodiment of the present invention; and

FIG. 5 is a sequence diagram of a recording rate calculation process in an image recorder of a third embodiment of the present invention.

### DETAILED DESCRIPTION OF THE INVENTION

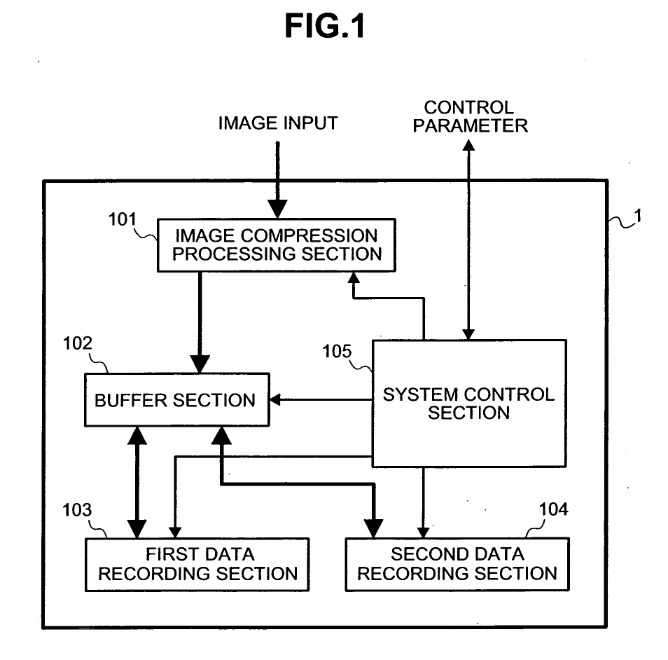

Below, embodiments of the present invention are described by referring to the accompanying drawings. FIG. 1 is a schematic diagram showing an image recorder of a first embodiment of the present invention. FIG. 1 shows an image recorder 1, an image compression processing section 101, a buffer section 102, a first data recording section 103, a second data recording section 104, and a system control section 105.

In image recorder 1, image compression processing section 101 receives an incoming image and applies an image compression process exemplified by MPEG2, MPRG4, JPEG, or others. The result is output as compressed image data. Buffer section 102 buffers the compressed image data provided by image compression processing section 101. First data recording section 103 records the image data that has been buffered by buffer section 102. Second data recording section 104 also records the image data that has been buffered by buffer section 102. System control section 105 exercises control over various processes, including the image compression process in image compression processing section 101, the buffer process in buffer section 102, and the image data recording process both in first data recording section 103 and second data recording section 104. First data recording section 103 serves as main recording means, and is a large-capacity recording medium such as HDD, DVD, or others. Second data recording section 104 serves as alternative recording means to first data recording section 103, and is a relatively-small-capacity recording medium such as a memory card configured by semiconductor memory. Under normal operation, system control section 105 applies control to make a recording to first data recording section 103, i.e., the large-capacity recoding medium.

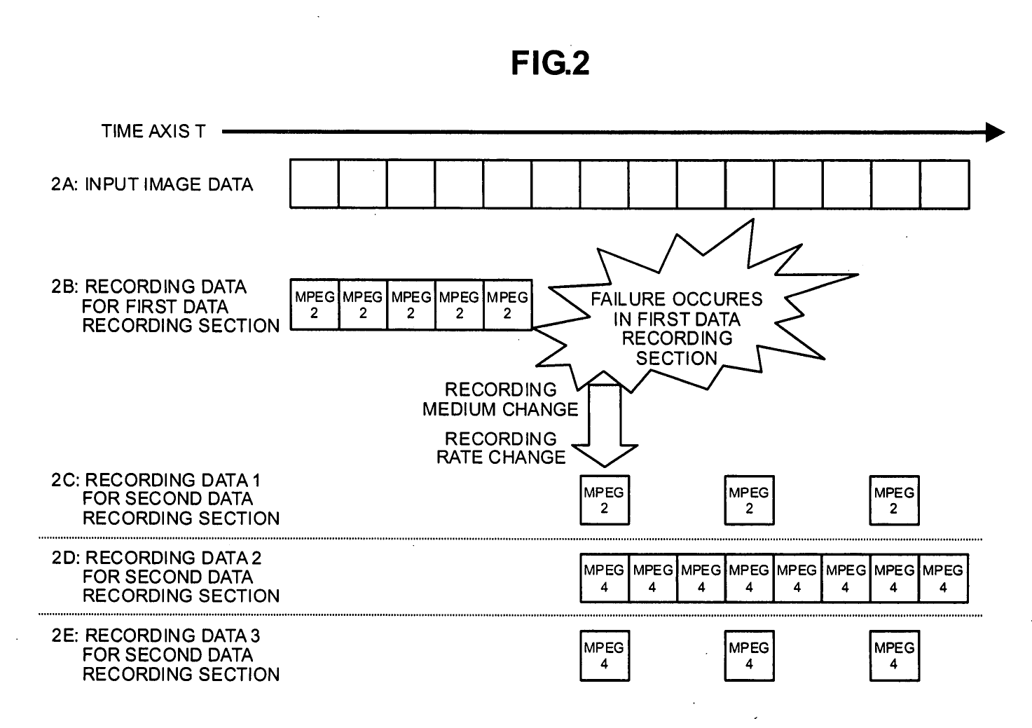

FIG. 2 is a diagram showing an exemplary method for image data recording control in the image recorder of the first embodiment of the present invention. FIG. 2 shows input image data 2A, image data 2B to be recorded by the first data recording section, image data 1 2C to be recorded by the second data recording section, image data 2 2D to be recorded by the second data recording section, and image data 3 2E to be recorded by the second data recording section. In the image recorder, under normal recording operation, input image data 2A is recorded into large-capacity first data recording section 103 after being compressed as image data 2B under compression schemes of low compression rate such as MPEG2. If first data recording section 103 becomes unavailable for the purpose of continuing the recording process, for example due to failures, second data recording section 104 is put in charge for recording as an alternative to first data recording section 103, and the recording rate is changed image data 2C for recording into second data recording section 104. Image data 2C shown in FIG. 2 has a reduced frame rate. Alternatively, the compression rate may be increased from low to high, or the recording data may be reduced. Such recording data decimation may be performed at the time of image compression in image compression processing section 101, at the time of buffering by the buffer section 102, or at the time of image data recording to second data recording section 104.

When the image compression processing section 101 is capable of image compression with a plurality of image compression schemes, before recording into the first data recording section 103, image data 2B is normally compressed at a low compression rate with MPEG2, as shown in FIG. 2. When first data recording section 103 becomes unavailable for recording, as shown in FIG. 2, image data 2D is compressed at a different, higher compression rate with MPEG4 for recording into second data recording section 104. Alternatively, as shown in FIG. 2, image data 2E may be compressed, with any different compression scheme with a reduced frame rate, for recording into second data recording section 104.

As such, when first data recording section 103 becomes unavailable for recording due to failures or other problems, the recording medium is changed to second data recording section 104 for recording, and the data recording rate is reduced through frame rate decimation and/or compression rate/scheme change. In this manner, second data recording section 104, with relatively smaller capacity, can be available for long-time recording.

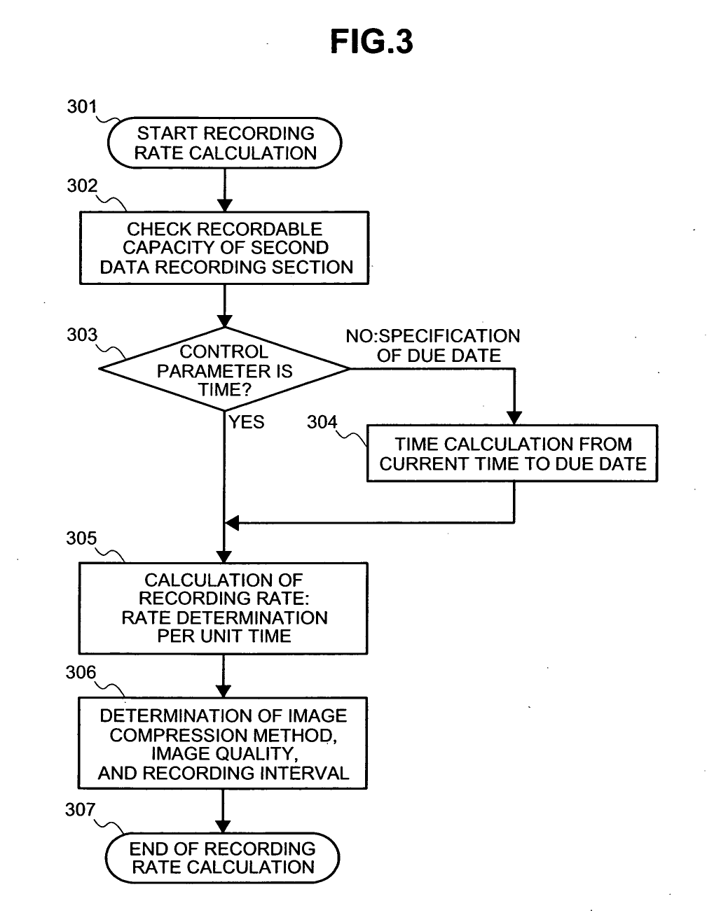

FIG. 3 is a sequence diagram of a recording rate calculation process in the image recorder of the first embodiment of the present invention. When the first data recording section 103 becomes unavailable for recording due to failures or other problems, system control section 105 executes the above-described process of second data recording section 104 activation and recording rate reduction. Referring to the drawings, the sequence for changing the recording rate will now be described.

In step 301, when first data recording section 103 becomes unavailable for recording, system control section 105 calculates the recording rate for making a recording into second data recording section 104. In step 302, system control section 105 then checks the capacity of second data recording section 104 that is available for recording. The capacity of second data recording section 104 may be acquired therefrom in step 302, or previously at system start-up or at the time of the memory card insertion/connection of system-addition for second data recording section 104. In step 303, a control parameter is determined to define the length of time that second data recording section 104 is available for image recording. When the control parameter is determined to be a time frame of, for example, 12 hours or a day, the procedure goes to step 305. When the control parameter indicates a time and date such as 12 o'clock on Monday or 12 o'clock on January 4, the procedure goes to step 304 to calculate time for recording using the current time and the due date. In step 305, the recording rate per unit time is computed using the capacity of the second data recording section 104, and the control parameter or the time derived in step 304. In step 306, this computed recording rate per unit time is used to determine the factors of image compression scheme, image quality/compression rate, and recording interval. In order to determine the factors of step 306, a table may be provided in advance for conversion between the recording rate and those factors. In step 307, the calculation of recording rate is terminated for recording to the second data recording section 104, and then using the factors determined in step 306, i.e., the image compression scheme, the image quality/compression rate, and the recording interval, the recording is started into the second data recording section 104. In an alternative manner embodiment, not only the data rate of the image data, but also the data rate of management information of the image data may be used for computation of the factors determined from the recording rate in step 306.

To determine the recording rate per unit time through recording rate calculation in step 305, the recording rate may be varied according to the time frame, e.g., the recording rate may be set higher during business hours than after business hours. Thus the recording rate according to the circumstances of monitoring objects may be determined, and the time frame during business hours may be monitored more intensively.

In the above description, the system control section 105 checks the capacity of the second data recording section 104 and the control parameter to automatically determine the image compression scheme, image quality/compression rate, and recording interval. Alternatively, the recording rate may be regarded as the control parameter for determination of image compression scheme, image quality/compression rate, and recording interval factors, or image compression scheme, image quality/compression rate, and recording interval are all directly regarded as the control parameter.

As such, even if first data recording section 103 does not work correctly, smaller-capacity second data recording section 104 can continuously perform recording with a guaranteed recording time by automatically determining the recording rate for second data recording section 104 using the control parameter, and by performing recording using a recording rate different from the recording rate of first data recording section 103. Accordingly, even if first data recording section 103 becomes unavailable for recording, after failure detection non-recording time periods are prevented and continuous recording is ensured for a predetermined length of time, such as for 12 or 24 hours or until Monday noon, for example. This continuous recording provides time for security firm staffs to travel to places where the image recorders are located after being alerted by failure detection. Security firms will be able to reduce operation costs by the decreased need for emergency staff allocation for failure support at night and weekends.

According to the first embodiment of the present invention, an image recorder is provided that is capable of ensuring continuous recording time, irrespective of the image recorder's placement conditions or of the failure or compromising of the main recording means among its multiple recording means, by using substitute recording means with a recalculated recording rate different from the recording rate of the main recording means. This image recorder decreases operation costs caused by urgent security firm staff dispatch at night and weekends for image recorder failure support and reduces maintenance staff allocation for image recorder maintenance.

### Second Embodiment

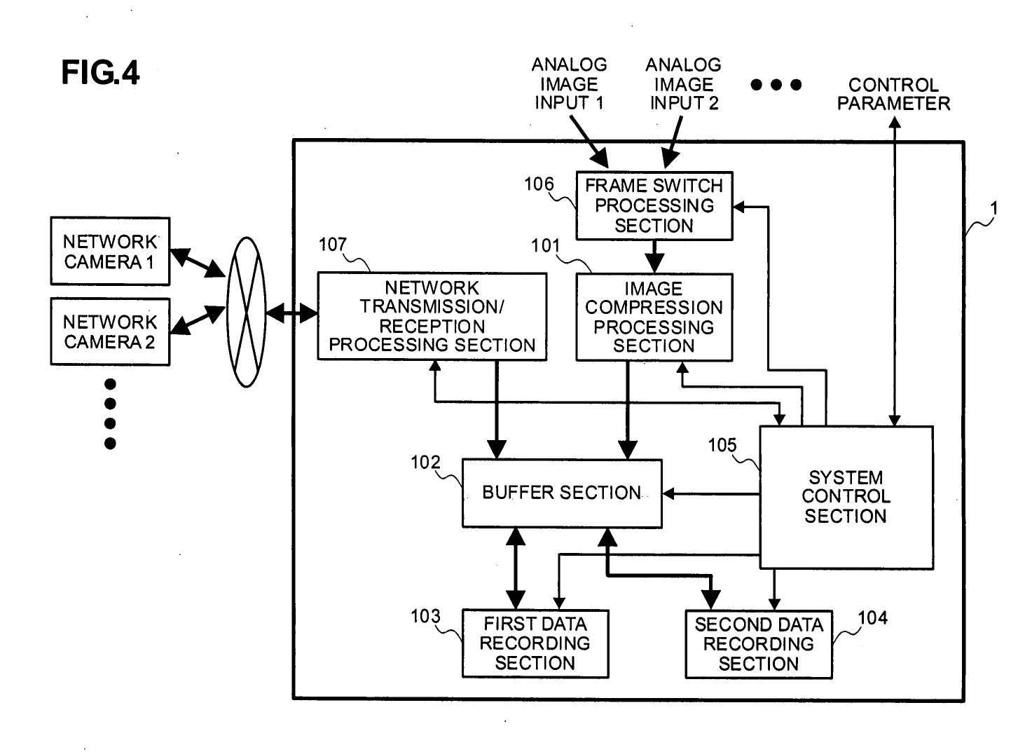

Turning to FIG. 4, a schematic diagram of a second embodiment of the present invention illustrates an image recorder. In FIG. 4, frame switch processing section 106 and network transmission/reception processing section 107 are added to the embodiment shown in FIG. 1. Frame switch processing section 106 applies a switching process to analog image signals coming from a plurality of input sources, and the resulting images, having been switched on a frame basis, are forwarded to image compression processing section 101. Network transmission/reception processing section 107 forwards, to buffer section 102, image data coming from network cameras connected over a network. Network transmission/reception processing section 107 also goes through a control data transmission/reception process to exercise control over the network cameras. System control section 105 exercises control over various processes, including the switching process by frame switch processing section 106, the image data reception process of network transmission/reception processing section 107, the transmission/reception process of the control data including the image quality or transmission rate of the image data provided by the network cameras, and the buffering process in buffer section 102 for the image data coming from the input sources. In synchronization with the switching process, image compression processing section 101 is also controlled. Due to control applied to various processes, the image data coming from the input sources can be recorded to the first or second data recording section 103 or 104.

According to the second embodiment of the present invention, in the image recorder for recording image data coming from a plurality of input sources, even if first data recording section 103, serving as main recording means, becomes unavailable for recording due to failures or other problems, second data recording section 104 works as substitute recording means with a recording rate different from that of first data recording section 103. The substitution of second data recording section 104 for first data recording section 103 as recording means is indicated when second data recording section 104 is put in charge of recording, the recording rate per unit time that resulted from step 305 of FIG. 3 is allocated among the input sources, and image compression scheme, image quality/compression rate, and recording interval are determined in step 306 for every input source. In the algorithm of allocating the recording rate per unit time among a plurality of input sources, an allocation factor may be simply the number of input sources, or the recording rate ratio among the input sources at the time of recording into first data recording section 103. Alternatively, allocation may be carried out in such a manner that the recording rate is set higher for any one input source specified by the control parameter. Further, to change the recording rate of the image data coming from the cameras connected over the network, system control section 10S may forward the control data via network transmission/reception processing section 107. For data decimation only in the direction of time axis, the data may be decimated when it is recorded from buffer section 102 to second data recording section 104.

As such, according to the second embodiment, in the image recorder that receives image data from a plurality of input sources, even if the image recorder's main recording means among other recorder means does not work correctly, the recording rate is calculated again to derive a different value for use for recording into a substitute recording medium so that the recording time is ensured irrespective of the number of input sources or the placement conditions of the image recorder. This image recorder decreases operation costs caused by urgent security firm staff dispatch at night and weekends for image recorder failure support and reduces maintenance staff allocation for image recorder maintenance. Note here that, in the above description referring to FIG. 4, the image inputs for the frame switch processing section are analog. This is not restrictive, and the image inputs can be, but are limited to, digital.

### Third Embodiment

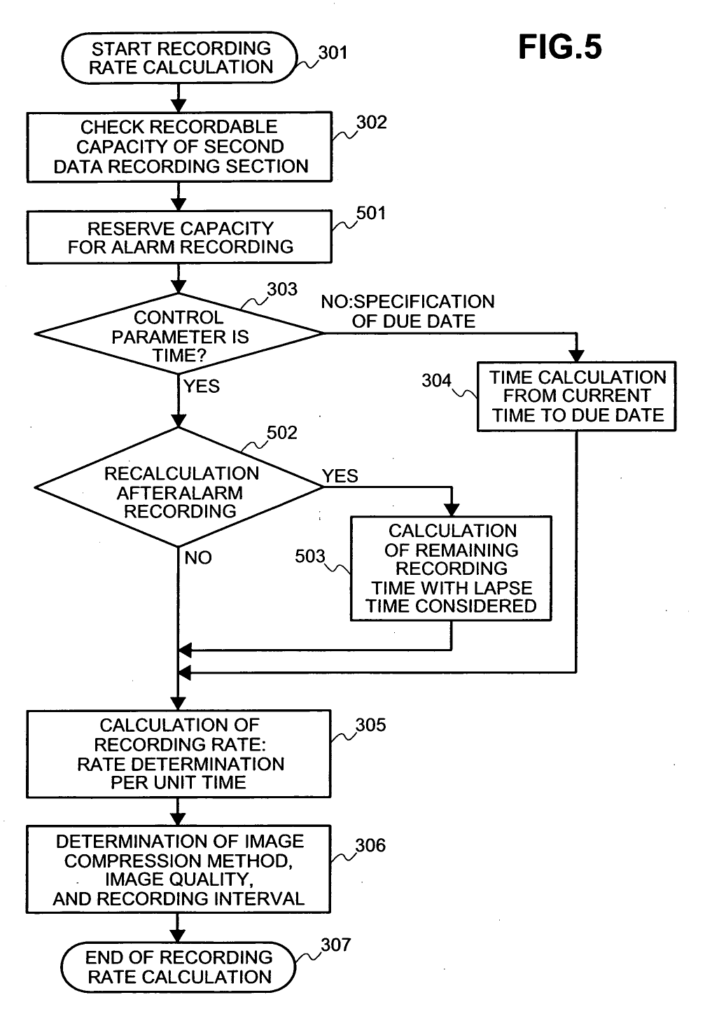

FIG. 5 is a sequence diagram of a recording rate calculation process in an image recorder of a third embodiment of the present invention. In FIG. 5, steps 501, 502, and 503 are shown in addition to the steps shown in FIG. 3.

Image recorders used for monitoring are required to have an alarm recording capability for recording any important data with high image quality. When crime or alarm detection occurs, this capability serves to monitor sensors, for example. For alarm recording, a recording is required to be made with high image quality, i.e., at a higher recording rate. Therefore, if an alarm recording is to be made into second data recording section 104 during operation as substitute recording means, the recording rate is required to be higher for alarm recording than the rate determined in step 305 of FIG. 3 so that the larger recording capacity will be used. This results in a recording time that is shorter than the time originally guaranteed by the image recorders. As shown in step 501 of FIG. 5, prior to the recording rate calculation process, system control section 105 computes the usable recordable capacity to be reserved for the alarm recording prior to an alarm alert. In the process of step 303, the recordable capacity of the second data recording section is subtracted by the capacity needed for alarm recording, and the resulting capacity is used for computation.

By reserving the capacity for alarm recording in step 501, it becomes possible to guarantee the recordable time even if an alarm recording is required. The amount of the capacity for alarm recording to be reserved in step 501 is not restricted, and may be for one-time recording or plural-time recording. In preparation for the next alarm recording after an alarm recording is made, the recording rate may be calculated again by going through the sequence of FIG. 5 for the recording rate calculation. In step 502, a determination is thus made as to whether or not the recording rate is recalculated after an alarm recording, and if the recording rate is determined to have been recalculated, the remaining recording time is calculated incorporating the time taken for the recording by second data recording section 104 in step 503. For example, assuming that an alarm recording is required after 1.5 days out of the guaranteed time of 2 days, this is the algorithm for an exemplary case of ensuring recording for the remaining 0.5 day.

As such, according to the third embodiment of the present invention, in an image recorder capable of alarm recording, even if its main recording means among other recording means does not work correctly, recordable capacity is reserved for alarm recording and the recording rate is calculated again to derive a different value for use for recording into a substitute recording medium so that the recording time is ensured. This image recorder decreases operation costs caused by urgent security firm staff dispatch at night and weekends for image recorder failure support and reduces maintenance staff allocation for image recorder maintenance.

According to the first to third embodiments, an image recorder is provided that is capable of ensuring recording time irrespective of the image recorder's placement conditions and even if its main recording means fail to work correctly, i.e., even if the main recording means is not available for recording.

What is claimed is:

1. An image recorder, comprising:
an image compression processor for compressing input image data;
a buffer for buffering image data as a result of compression by the image compression processor;
a first data recorder for recording buffered image data;
a second data recorder for recording the buffered image data; and
a system controller for controlling the image compression processor, the first data recorder and the second data recorder; wherein
in normal operation, the system controller causes the image data to be recorded into the first data recorder with a first recording rate, and if the first data recorder is not available for recording, the system controller causes the image data to be recorded into the second data recorder with a second recording rate that is different from the first recording rate.

2. The image recorder according to claim 1 further comprising a frame switch processor coupled to the image compression processor for switching image signals from a plurality of input sources and providing them to the image compression processor.

3. The image recorder according to claim 1 further comprising a network transmission/reception processor to control data and image data of a plurality of network cameras connected over a network, wherein the buffer buffers the image data received by the network transmission/reception processor.

4. The image recorder according to claim 1 wherein:
the image compression processor compresses the input image data with one of a plurality of image compression techniques; and
the system controller causes the image data compressed by a first compression technique to be stored in the first data recorder, and records the image data compressed by a second compression technique different from the first compression technique into the second data recorder.

5. The image recorder according to claim 1 wherein the system controller determines the second recording rate with a control parameter of recording time or due date.

6. The image recorder according to claim 1 wherein the second recording rate varies based on time.

7. The image recorder according to claim 1 wherein the system controller controls a recording rate of each of a plurality of input sources to the first data recorder and determines a different recording rate for each of the input sources for recording into the second data recorder.

8. The image recorder according to claim 1 wherein the system controller determines the second recording rate after reserving capacity for an alarm recording.

9. The image recorder according to claim 1 wherein the first data recorder comprises a hard disk drive and the second data recorder comprises a memory card.

10. An information recorder comprising:
an information compression processor for compressing input information;
a buffer for buffering the compressed input information;
a first data recorder for recording information from the buffer;
a second data recorder for recording information from the buffer; and
a system controller for controlling the information compression processor, the first data recorder, and the second data recorder, wherein
in a first mode of operation, the system controller causes the compressed input information to be recorded in the first data recorder with a first recording rate, in a second mode of operation causes the compressed input information to be recorded in the second data recorder with a second recording rate, where the second recording rate is different from the first recording rate.
